(19) United States
(12) Patent Application Publication
(10) Pub. No.: US 2018/0256433 A1
(43) Pub. Date: Sep. 13, 2018

(54) KNEE REHABILITATION THERAPY DEVICE

(71) Applicants: Richard R. Pucci, Rydal, PA (US); Ronald Roop, Warminster, PA (US)

(72) Inventors: Richard R. Pucci, Rydal, PA (US); Ronald Roop, Warminster, PA (US)

(73) Assignee: 4R SOLUTIONS, LLC, IVYLAND, PA (US)

(21) Appl. No.: 15/916,581

(22) Filed: Mar. 9, 2018

Related U.S. Application Data
(60) Provisional application No. 62/469,573, filed on Mar. 10, 2017.

(51) Int. Cl. A61H 1/02

(52) U.S. Cl. CPC A61H 1/024; A61H 2205/102; A61H 2201/1269

(57) ABSTRACT

Knee and limb joint rehabilitation therapy device for straightening a limb joint of a person after injury thereto or before or after surgery, particularly partial or total knee replacement surgery which applies an adjustable corrective and therapeutic force to the affected joint and surrounding muscles above and below the joint by means of a pair of bridged compression pads connected to a support member that can be manually operated by the patient with or without the aid of medical personnel, is simple to use, compact, and is adjustable to accommodate different limb sizes and may be used in a variety of rehabilitation regimens.

This invention relates to knee rehabilitation therapy devices. More particularly, the invention here is directed to a passive knee rehabilitation device for straightening a knee joint of a person after injury thereto or before or after surgery, particularly partial or total knee replacement surgery. The knee rehabilitation therapy device of the present invention applies an adjustable corrective and therapeutic force to the knee joint and surrounding muscles above and below the knee by means of a pair of bridged compression pads connected to a support member which may be manually operated by the patient. The device, which can be can be used by a patient with or without the aid of medical personnel, is simple to use, compact, and is adjustable to accommodate different leg sizes and may be used in a variety of rehabilitation regimens.

To achieve maximum stretch of affected tissues of the knee joint, the device of the present invention can be used without the need for lower extremity muscle involvement. In one embodiment the device may be fabricated from a lightweight structural metal, such as titanium, aluminum or magnesium. In other embodiments, high density plastics and other similar materials may be employed alone or in combination with lightweight structural metals. When a patient uses the novel knee therapy device of the present invention the knee joint may be comfortably flexed and straightened by manual operation of a centrally disposed lever which applies downward force to the compression pads thus causing the knee joint to comfortably extend to its maximum range.

### BACKGROUND OF THE INVENTION

The knee and movements at the knee joint are essential to many everyday activities, including walking, running, sitting and standing. The knee is one of the largest and most complex joints in the body; it is also one of the strongest and most important joints in the human body. The knee joint allows the lower leg to move relative to the thigh while supporting the body's weight and movement. Anatomically, the knee, also known as the tibiofemoral joint, is a synovial hinge joint formed between four bones, namely, the femur, tibia, fibula and patella.

Repetitive use of a joint, such as the knee, over time tends to reduce the stability of the knee. In cases of injury through accident or sports related causes, instability of the knee can be exacerbated and worsened to the point that without immobilization or support of the knee joint by an orthotic, a person cannot bear the weight or their own body upon the knee joint. Or to do so, results in great pain, which is usually treated with pain medications that can be addictive and detrimental to the liver and other important organs of the body. Further, when there is a lack of movement of a patient due to knee instability, a sedentary lifestyle is usually taken up, which can result in a reduction of body energy, weight gain, atrophied muscles, especially around the knee joint, and a general depression of mental state due to the lack of ability of the person to be self-sufficient and mobile.

The loss of ability to flex the knee joint is known as an extension contracture. People develop extension contractures in knees and other joints from many and various causes including, most notably, knee replacement surgery and injury due to trauma. While non-surgical therapeutic treatments are often attempted for initial treatment of certain types of knee joint injuries, there are situations where knee surgery becomes the recommended or necessary treatment for different conditions that can cause knee pain. The three most common knee surgeries are meniscectomy, which is a repair of the meniscus, repair of the anterior cruciate ligament and complete joint replacements. There are over 600,000 knee replacements performed each year in the United States and with an aging population staying in the workforce longer and with obesity on the rise, demand for total knee replacement surgery is expected to exceed 3 million by the year 2030.

Knee replacement or knee arthroplasty, is a surgical procedure to replace the weight-bearing surfaces of the knee joint to relieve pain and disability. It is most commonly performed for osteoarthritis and also for other knee diseases such as rheumatoid arthritis and psoriatic arthritis as well as trauma. Knee replacement surgery can be performed as a partial or a total knee replacement. In general, the surgery consists of replacing the diseased or damaged joint surfaces of the knee with metal and plastic components shaped to allow continued motion of the knee.

A partial knee replacement is surgery to replace only one part of a damaged knee. It can replace either the inside (medial) part, the outside (lateral) part, or the kneecap part of the knee. A total knee replacement is a surgical procedure whereby the entire diseased knee joint is replaced with artificial material. The knee is a hinge joint which provides motion at the point where the thigh meets the lower leg. The thighbone (or femur) abuts the large bone of the lower leg (tibia) at the knee joint. During a total knee replacement, the end of the femur bone is removed and replaced with a metal shell. The end of the lower leg bone (tibia) is also removed and replaced with a channeled plastic piece with a metal stem. Depending on the condition of the kneecap portion of the knee joint, a plastic “button” may also be added under the kneecap surface. The artificial components of either a partial or a total knee replacement are referred to as the prosthesis.

Individuals, who have suffered knee joint trauma and damage, typically require some rehabilitative therapy so that an optimum range of motion can be achieved for the affected joint. Following partial or total knee replacement surgery, it is, in fact, imperative that the patient undergo rehabilitative therapy in order to recover full range of motion in the affected joint.

For example, after total knee replacement, the knee frequently does not recover its normal range of motion (0-135 degrees usually). Most patients can achieve 0-110 degrees, but stiffness of the joint often occurs. In some situations, manipulation of the knee under anesthetic is used to reduce post-operative stiffness. There are also many implants from manufacturers that are designed to be “high-flex” knees, offering a greater range of motion; however, it is widely accepted that exercise and physical therapy are necessary elements of any post-operative recovery regimen.

Physical therapists provide a variety of interventions, such as manual therapy techniques, balance, coordination, and functional retraining techniques, knee taping techniques, electrical stimulation, and foot orthotics to assist in overcoming some of the barriers that make participation in exercise and physical activity difficult. For post-operative knee replacement therapy in order to obtain full joint flexibility and function, the associated discomfort and restricted range of motion often leads to an observed decrease in patient compliance with any therapeutic protocol.

Knee flexion and extension range of motion is necessary for functional and sport specific activities. Loss of full range of motion at the knee joint can have detrimental effects on the function of the entire lower extremity. For example, decreased knee flexion or extension range of motion has been reported following anterior cruciate ligament (ACL) reconstructions, total knee arthroplasties, arthro-fibrosis of the knee, and other musculoskeletal injuries involving the knee joint. Loss of knee flexion has been demonstrated to cause altered gait pattern affecting the ankle and hip, limited functional squatting, and difficulty negotiating stairs and sitting. The loss of knee extension can cause altered gait pattern affecting the ankle and hip, inability to attain the closed packed position of the knee, and difficulty walking, running and jumping.

Due to the complications that can occur following the loss of knee flexion or extension, regaining full functional range of motion through treatment is crucial. Research supports the use of sustained force for 10 to 45 minutes at a time to increase knee range of motion. Sustained force is particularly effective for long standing joint restrictions which may not be responding to intermittent force to regain range of motion.

Currently, physical therapists use manual pressure or mechanical devices such as the Elite Seat® (Kneebourne Therapeutics, Noblesville, Ind.) to attain sustained knee flexion or extension. The challenges with manually or hands-on applied pressure include the amount of time involved and a physical therapist is required to generate a great deal of force commonly leading to fatigue. Also, the force can be inconsistent from one session to the next. Problems with mechanical devices that produce sustained pressure include the lack of availability and the cost associated with such devices.

Unless there is constant supervision by a qualified physical therapist compliance with existing knee correction devices and continuous passive motion devices tends to be low due to complexity, difficulty-of-use, and/or cost of these devices. Because of the frequency of the physical therapy regimen, hands on treatment by a physical therapist is often both costly and time consuming, thus creating the need for self-administered knee joint rehabilitation therapy and rehabilitation therapy devices.

The knee rehabilitation therapy device of the present invention provides a simple, cost-efficient, comfortable, adjustable and easy-to-use solution. Unlike many prior art solutions, there are no assemblies of straps or buckles required to attach the device to a lower extremity during a therapy session nor are there cumbersome apparatuses which cannot be easily stored or adjusted. The invention of interest here can be easily used and adjusted by the patient and can be readily partially dissembled or collapsed for storage.

Examples of prior art devices for supporting the knee after injury can be seen as far back as U.S. Pat. No. 3,581,741, which discloses a knee brace comprising an upper rigid body portion and a lower rigid body portion pivotably coupled together on the lateral side in a manner so that they may pivot relative to each other about an axis generally perpendicular to the zone of overlap and may slide relative to each other in all radial directions generally parallel to the zone of overlap. These types of devices are best used in connection with supporting the knee joint and are intended for everyday wear. While effective for their intended purposed, they are not particularly useful in a rehabilitation therapy context.

It is first important to consider the two types of range of motion in the rehabilitation context. An active range of motion occurs when a patient moves a joint through its range of motion, whereas a passive range of motion involves a third party or a device moving a joint for the patient. For example, anytime a patient moves his or her arm or bends his or her knee that would be considered an active range of motion. An example of passive range of motion would be when a physical therapist is rehabilitating a joint, such as the knee joint, and moves it for you without your assistance.

Various devices have been developed for exercise of the knee joint. These can be considered either active or passive motion devices. U.S. Pat. No. 6,821,262 discloses a device for increasing the range of motion of the knee joint following knee surgery having an elongated member with a handle at one end, a harness for holding the patient's foot attached to the other end, and an adjustable slider assembly that can be positioned at a variety of locations along the elongated member. A fulcrum, which is attached to the slider assembly, rests on the top of the patient's leg, either above or below the knee, while the harness holds the patient's foot. The device is operated by the patient pulling on the handle, thereby straightening the leg.

U.S. Pat. No. 6,962,570 describes a knee extension therapy apparatus for use by a patient in a recumbent position having the foot of his leg to be treated elevated to a level above the surface upon which the patient user is resting. The apparatus is equipped with a force translation pulley system, which subjects the knee to straightening forces when the patient pulls on a cord.

U.S. Pat. No. 5,855,538 teaches an exercise device that allows the use to extend each leg separately from a sitting position employing a pair of upwardly curved tracks affixed to horizontal base members by the rear support members and to vertical base members by the top support members. Two foot plates are affixed to tracks by the foot plate attachment to move forward and rearward.

U.S. Pat. No. 5,685,830 discloses an adjustable orthosis for stretching tissue by moving a joint between first and second relatively pivotal body portions including a first arm with a releasable cuff and a second arm with a releasable cuff at its outer end. The arms are pivotally interconnected and an actuator is connected to the arms to apply force to the arms to pivot them relative to each other to move the joint. The actuator includes flexible force transmitting member connected with at least one of the arms. A drive assembly is provided to tension the flexible force transmitting member and move the first and second arms relative to each other.

U.S. Pat. No. 4,974,830 teaches a support structure for the knee joint driven through alternating flexion and extension by applying a motorized external force to the knee joint across a mechanical pivot point via a drive tube. A foot support is provided which is cantilevered from the end of a calf support drive bar that supports the calf and thigh and is attached an end of the drive tube to the horizontal bed frame at the end of the hospital bed. This device requires careful anatomical alignment of the support structure with the leg and strict monitoring of the motorized external force loads applied to the leg joints to prevent post-operative injury to the joint during rehabilitation thereof. Furthermore, such devices are relatively complex and cumbersome to operate and maintain, as well as costly to produce

Other prior art examples of joint rehabilitation devices include U.S. Pat. No. 5,236,333 which discloses a leg exerciser that is placed directly on the knee joint and operated by the user. The leg exerciser includes an L shaped set of parallel rods, between which the foot may be engaged and supported between the rods. The knee itself serves as a pivot for the exercising of a leg. A knee pad is engaged on the rods over the knee. There is a handle at the end of the L shape of the rod which can be used for leverage for exercising the leg pivoting on the knee.

U.S. Pat. No. 4,844,454 pertains to a self-operable knee therapy device using two platforms which secure the upper and lower portions of the leg and an elongate central support member pivotally joined at its upper end to the joined ends of the two platforms. A handle is coupled to the first platform to enable grasping by manual movement of the handle such that the lower leg can be pivoted relative to the upper leg of a person in a selective manner to exercise and rehabilitate the knee and/or leg muscles.

U.S. Pat. No. 5,254,060 teaches a motorized unit for exercising legs and/or arms of a patient to enhance blood circulation, strengthen the muscles of the patient and provide a range of joint motion to prevent joint “freeze-up”. The unit is adaptable for use with the patient either in a chair or reclining in a bed.

U.S. Pat. No. 5,509,894 discloses a leg suspension device for rehabilitative exercise of the leg, and specifically for passive or active range of motion exercise of the knee or hip joint. The device includes a bar having proximal and distal segments, and a fulcrum rotatably engaging the bar between the proximal and distal segments to permit rotation of the bar about the fulcrum in a vertical plane. Upper and lower leg cuffs are connected to the proximal and distal segments, respectively, suspending the thigh and leg while isolating the knee joint. A base is provided to free-standingly support the device during use, or, alternatively, the device is adapted for affixing to an overhead anchor.

U.S. Pat. Nos. 5,896,459 and 5,254,067 to Habing et al. that disclose leg exercise devices which use pistons or a flywheel and generator to provide resistance to leg movement, and U.S. Pat. No. 5,803,883 to Patrylak et al., U.S. Pat. No. 5,338,274 to Jones, and U.S. Pat. No. 4,542,900 to Ray teach exercise devices that employ weights, similar to machines found in gymnasiums.

Lastly, U.S. Pat. Nos. 5,456,268, 5,395,303, 5,285,773, 5,213,094, and 5,167,612 to Bonutti teach complex mechanical devices utilizing wires, pulleys, and cuffs to exercise or rehabilitate a patient's arm, although ‘094 discloses application to a knee joint as well.

Therefore, it can be seen that knee joint rehabilitation devices of all types are useful only if they assist a person in returning to a more normal lifestyle or at least one that is significantly less sedentary when compared to the immobile person with an instable knee. It can be said that proper rehabilitation of the knee joint is essential to complete body health and a proper state of mind.

It is also well known, as complaints are abundant, that not all knee rehabilitation therapy devices that assist in exercising and /or stabilizing the knee are comfortable or easy to use. In fact, too many apply unwanted pressure upon the thigh and the shin of the patient when flexing the knee joint. This is because most prior art devices made from very hard and rigid materials that do not flex and move with the changing conditions of the body (i.e., expansion and contraction of the leg musculature) or which are too difficult to use because they require precise adjustment, which in turns incentivizes the patient to remain sedentary and results in the degradation of the physical state.

Additionally, although some prior art devices provide for knee joint mobility, many have no utility for flexion and extension exercise of the knee joint. Some devices are required to be worn and may be cumbersome to use and adjust. Other device may put uneven pressure on one portion of the leg and may cause strain to the musculature of the leg or to the joint of the knee or the hip. As such, it is an object of the present invention to provide a device for therapy and rehabilitation of the knee joint, which is relatively inexpensive to produce, and relatively simple to operate and maintain.

It is also an object of the present invention to provide a device for rehabilitation of the knee joint which is readily adaptable to different size users without requiring careful anatomical alignment of the device with the knee joint. It is a further object of the present invention to provide a device that can passively apply a controlled manual force to the knee joint for range of motion exercise thereof with a relatively low risk of injury to the joint. Lastly, it is another object of the present invention to provide a device that can actively apply a desired degree of the user's own leg muscle force to the knee joint for range of motion exercise of the joint without bearing weight thereon.

### BRIEF SUMMARY OF THE INVENTION

The invention relates to a device for treating range or motion impairments in knee joints from extension contracture following knee replacement surgery, weakness in the supporting musculature, or some other malady in inhibiting the integrity of the knee joint in accomplishing full functionality.

The present invention provides several embodiments of a knee rehabilitation device, which can be used by an individual to assist the rotational component of the affected knee joint through its normal anatomical plane. It may be performed with or without the need of lower extremity muscle involvement. It is optimum to reduce lower extremity muscle recruitment in order to achieve a maximal stretch to the affected tissues related to the pathologic joint.

One embodiment of the knee rehabilitation device of the present may be fabricated from a lightweight structural metal, such as titanium, aluminum or magnesium. The device includes a generally rectangular tubular arm of telescopically adjustable length that is preferably offset, and pivotally coupled at one end to a foot support for engaging the heel portion of a patient's foot, a moveable pivotally connected bridge support member having a pair of pivotally supported pads and an arm handle at the opposite end. Other embodiments may be constructed of composite materials including rigid plastics, made of a polymer matrix reinforced with fibers. The fibers are usually glass, carbon, aramid, or basalt and the polymers are typically epoxies, vinylesters and/or polyester thermosetting plastics and phenol formaldehyde resins. As used herein, rectangular tubular is intended to encompass shapes and structures other than rectangular such as round, triangular, pentagonal, and hexagonal, etc. and telescopically means complimentary shaped objects made of concentric tubular parts which are adapted to slide or which can cause to slide into itself, so that the arm becomes smaller or larger depending on the desired length. It will be appreciated that the desired length can be adjusted and set in place by any number of known mechanisms including rotational twist locks, ball detents and openings, spring loaded pins, friction fitments, etc.

While the patient is standing or either seated or in a reclined position with the patient's leg extended (in the case of reclining on a flat surface), the bridge member is adjusted on the adjustable tubular arm so that the bridge member can be placed generally centrally above the patient's knee joint with a first or distal pad extending downwardly and positioned generally at or near the upper portion of patient's shin and a second or proximal pad extending downwardly and positioned generally at or near the lower portion of the patient's thigh.

After positioning the respective pads on the appropriate areas of the patient's leg, the arm handle can be pulled downwardly towards the patient's leg thereby causing the two pads to engage the leg portions, pressing downwardly which causes the knee joint to comfortably extend to a degree acceptable to the patient for a prescribe period of time. The tubular arm may further include detents, ridges or locks for temporarily securing the position of the pads on either side of the patient's knee exerting roughly equal downward force above and below the knee simultaneously. The knee straightening exercises described using the device above can be repeated during the normal course of self-administered rehabilitation therapy. As the patient becomes accustomed to the therapy regimen, the length of time and the frequency of the knee rehabilitation therapy may increase and the knee joint can repeatedly be brought into an extended position until a maximum satisfactory and/or normal range of motion is achieved.

In an embodiment of the present invention, the generally rectangular tubular arm may alternatively include a slidably mounted fixed or adjustable sleeve fulcrum member adapted to receive a second tubular arm for providing leverage when the second arm handle is pulled downwardly in the direction of the patient's leg. This arrangement may facilitate more efficient use of the knee rehabilitation therapy device of the present invention while the patient is either in a seated position, when rehabilitation therapy commences and downward pressure may require careful adjustment or when downward pressure may even require some assistance by a physical therapist. The two pads extending downwardly from the tubular arm to engage the respective leg portions on either side of the knee joint, exerting downward pressure which causes the knee joint to extend to a degree comfortably acceptable to the patient for prescribed periods of time.

In still other embodiments of the present invention, the fixed or adjustable sleeve member may further include detents or ridges for temporarily securing the second arm in a fixed position while the two pads extending downwardly from the tubular arm engage the respective leg portions on either side of the knee joint. While in other embodiments of the present invention, timers, or mechanical and/or electronic measurement sensors may be provided to assist the patient in assessing the length of time of the treatment, the degree to which the knee angle is approaching optimal range of motion or a measurement of the downward pressure of the pads.

In yet other embodiments, the novel knee rehabilitation therapy device of the present invention may also employ a plurality of pad cushions or gel packs (collectively “pad cushions”) used as therapeutic and corrective force elements for the device. The cushions may be removably positioned along inner surfaces of one or both pads and may provide therapeutic relief in terms of heat, cold or medication to the knee joint musculature. A plurality of pad cushions can be employed such that force or therapeutic value can be applied on both sides of the knee joint, at the knee joint, directly above the knee joint on the inner and outer thigh area and directly below the knee joint on the inner and outer shin area. When employed in their respective pads the pad cushions also provide additional stabilization to the knee, prevent device slippage and provide an extra degree of comfort and/or medication to patient.

The knee rehabilitation therapy device of the present invention provides all of the advantages needed, which are mentioned above and which are currently deficient and wholly missing from the prior art. The present knee rehabilitation therapy device is used and indicated for partial or total knee replacement surgery, for increased medial, lateral, and rotational support and control of the knee joint following injury to or reconstruction of the anterior cruciate ligament (ACL) and posterior cruciate ligament (PCL) or protection of the collateral ligament of the knee.

The device of present invention provides also increased knee rehabilitation therapy for patients who have continued symptoms of significant knee instability such as giving way, which may be due to poor quadriceps or hamstring strength (i.e., hemiplegia), and especially for patients who have a desire for early resumption of activities after knee surgery. The present knee rehabilitation therapy device is also particularly useful after high tibia osteotomy, partial or total knee replacement and in some indications for hip replacement.

### BRIEF DESCRIPTION OF THE DRAWINGS

This invention can be best understood by those having ordinary skill in the art by reference to the following detailed description, when considered in conjunction with the accompanying drawings in which:

FIG. 1 is a partial phantom top plan view of the knee rehabilitation therapy device of the present invention;

FIG. 2 is a partial phantom right side view of the knee rehabilitation therapy device of the present invention;

FIG. 3 is a front view of a pad member of the knee rehabilitation therapy device of the present invention at the line 3-3;

FIG. 4 is a front view of the foot support of the knee rehabilitation therapy device of the present invention at the line 4-4;

FIG. 5 is a left side top perspective view of an alternate embodiment of the knee rehabilitation therapy device of the present invention;

FIG. 6 is a top plan view of another alternate embodiment of the knee rehabilitation therapy device of the present invention;

FIG. 7 is a left side view of the embodiment shown in FIG. 6;

FIG. 8 is a left side view of an embodiment of the present invention in use by a patient in a seated position prior to knee extension;

FIG. 9 is a left side view of an embodiment of the present invention in use by a patient in a seated position during full knee extension;

FIG. 10 is a left side view of an embodiment of the present invention in use by a patient in a reclined position prior to knee extension;

FIG. 11 is a left side view of an embodiment of the present invention in use by a patient in a reclined position during full knee extension;

FIG. 12 is left side perspective view of another embodiment of the present invention;

FIG. 13 is a right close up partial view of the embodiment shown in FIG. 12;

FIG. 14 is a top plan view of the foot support and offset segment of the embodiment shown in FIG. 12; and

FIG. 15 is a close up view of an offset segment of the embodiment shown in FIG. 14.

### DETAILED DESCRIPTION OF THE DRAWINGS

Before the subject devices, systems and methods are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

The present invention here is directed to a passive knee rehabilitation therapy device for straightening a knee joint of a person after injury thereto or before or after surgery, particularly partial or total knee replacement surgery by applying a therapeutic force to the knee joint and surrounding muscles above and below the knee by means of a pair of bridged compression pads connected to a support member. The device can be used by a patient with or without the aid of medical personnel and is adjustable to accommodate different leg sizes and may be used in a variety of rehabilitation regimens.

Unless defined otherwise, all technical and scientific terms used herein have the same meaning as commonly understood by one of ordinary skill in the art to which this invention belongs. For example, the terms vertical and horizontal are used herein relative to a standing human being in the anatomical position. The terms “anterior”, “posterior”, “superior” and “inferior” are defined by their standard usage in anatomy; “anterior” refers to the region towards the front and the term “posterior” refers to the region towards the back. The term “sagittal” refers to regions on either side of the central midline axis of a standing human being; “superior” is upward toward the head; and “inferior” is lower or toward the feet. In the case of devices, “distal” and “distally” are away from the body of the tool user and “proximal” and “proximally” are nearer or close to the body of the tool user.

The terms “upper” and “lower” are used herein to refer to the structure of the device members as shown in the referenced drawings with respect to a reference position of the device as it is intended to be used. A “superior” body surface is the upper or forward surface of the thigh or shin onto which the compression pads apply force and an “inferior” body surface is the lower or rearward portion of the thigh or shin supported by a flat or planar surface.

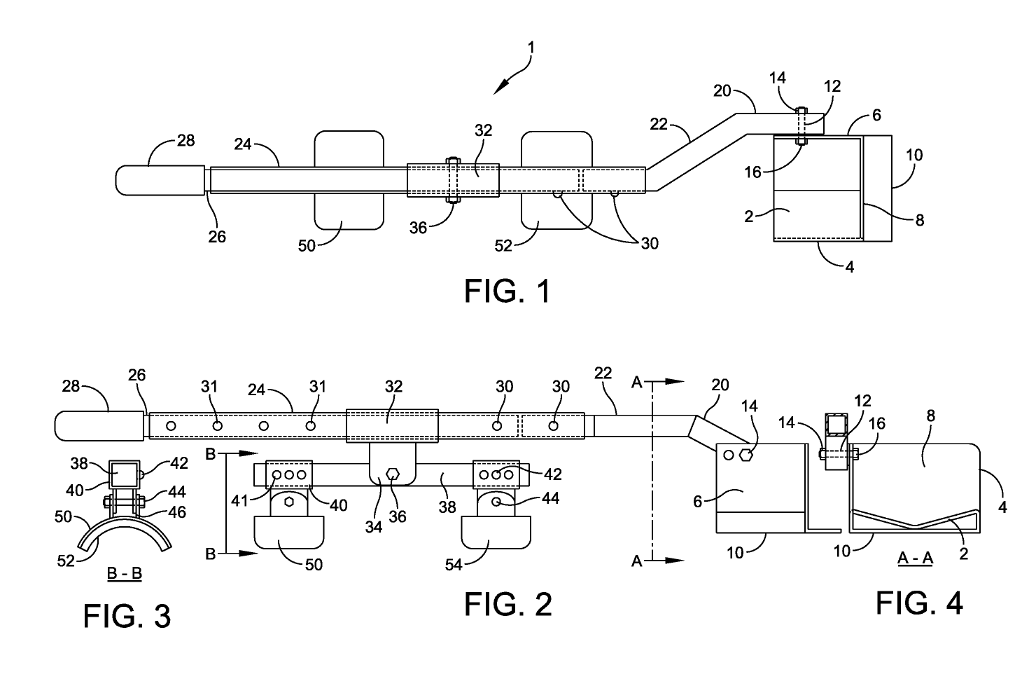

Referring to FIG. 1, there is shown the knee rehabilitation therapy device 1 for facilitating the range of motion in patient's knee, having at one end foot support 2 for engaging the heel portion of a patient's foot. Foot support 2 is generally rectangular defined by right sidewall 4, left sidewall 6, front wall 8 all of which are attached to foot support base 10. It will be appreciated that foot support 2 has three walls and is open on the opposite end of front wall 8 to accommodate the placement and positioning of a patient's foot. It will be further appreciated that foot support 2 will also accommodate feet of varying sizes. As is shown more clearly in FIG. 4, the lower interior surface of foot support 2 may be formed to place a patient's foot in a generally vertical or “toes-up” orientation which is optimal for use of the therapeutic device as disclosed. Although not shown, the interior surfaces of foot support 2, right wall 4, left wall 6 and front wall 10 may further include resilient pads or cushioning fabricated for patient comfort.

In the embodiment shown in FIG. 1, rotatably attached to left support wall 6 via handle securing pin 12 is distal arm end 20. Securing pin 12 is received by securing pin through openings (not shown) in both left side wall 6 and distal arm end 20. At one side of securing pin 12 is securing pin head 16 and at the opposite end securing pin lock nut 14. Pin lock nut 14 may also be selectively adjustable to increase or decrease the resistance in the downward movement of arm 24. It will be further understood that distal arm end 20 may be rotatably attached to either or both sides of foot support 2 and that other suitable securing means which allow rotational movement and/or which may be adjustable that are known in the art may be employed.

As is shown more clearly with reference to FIG. 1 and FIG. 2, adjacent distal arm end 20 is distal arm offset 22. Distal arm offset 22 is joined to and terminates inside of extension tube member 24. Extension tube member 24 houses adjustable arm 26. Adjustable arm 26 is slightly smaller in generally rectangular proportion than extension tube member 24 and is slidably movable within the interior of extension tube member 24. B all detents 30 detachably secure distal arm offset 22 to extension tube member 24 via ball detent openings 31. It will be appreciated that ball detents 30 and ball detent openings 31 as used in the present invention are examples of the types of connectors for detachably securing distal arm offset 22 and extension tube member 24 and that numerous other types of detachable connections well known within the art can be employed including but not limited to threaded thumb screws, twist lock type fittings, compression fitments, through pins and retainers as well as bead and recess type connectors for “snapping” the two segments together. It will be further appreciated that the exemplary detachably securing connections can be used either alone or in combination with other detachably securing devices and that these variations are well within the scope and spirit of the invention as more fully set forth.

Still referring to FIG. 1 and FIG. 2 it will be seen that also housed within extension tube member 24 is adjustable arm 26 which likewise is slidably movable within extension tube member 24 and is adjustable therein and secured in place via ball detents 30 and a plurality of ball detent openings 31. The plurality of ball detent openings 31 permits the patient to selectively move adjustable arm 26 proximally or distally allowing bridge support member 32 to a placed in position by the patient which is optimal for therapy. It will be understood that that adjustable arm 26 also allows the device to accommodate a variety of patients of different heights and leg lengths and essentially eliminates the need for customizing the device for each patient. Depending downwardly from bridge support member 32 is bridge arm tab 34. Bridge support member 32 is mounted on extension tube member 24. Bridge support member 32 may be fixedly mounted in place or it may be adjustable and secured in position with set screws, pins, and or ball detents and ball detent openings (not shown).

Connected to bridge arm tab 34 via compression pad pivot pin 36 is pad bridge arm 38. Compression pad pivot pin 36 allows pad bridge arm 38 to move in an up-down rocker-like fashion. Positioned at or near the proximal and distal ends of pad bridge arm 38 are adjustable pad supports 40 movably secured in place by arm detents 42 in arm detent openings 41. Depending downwardly from adjustable pad supports 40, bridge arm support tab 44 connected to pad support tabs 46 via pad pivot pin 45. Pad pivot pins 45 allow proximal compression pad 50 and distal compression pad 54 to move in up-down rocker-like fashion which further facilitates adjustment and correct placement of proximal compression pad 50 and distal compression pad 54 on the lower portion of the patient's thigh and the upper portion of the patient's shin, respectively, on either side of the patient's knee to provide relatively uniform therapeutic downward force when in use.

When measuring the relative value or effectiveness of the knee rehabilitation therapy device of the present invention, it will be understood that this is frequently measured by the angular displacement of the knee which indicates the extent to which the lower leg of the patient has rotated relative to the upper leg. In an embodiment of the present invention, the apparatus is configured such that after rotation of the lower leg has ceased or reached its maximum (R-max), the apparatus can be temporarily “locked” in place to maintain the knee its displaced R-max position and to maintain the degree to which the lower leg has rotated relative to the lower portion of the upper thigh. In this embodiment as well as other embodiments, it will be understood that the relative R-max of a given knee joint may include both a physical measurement such as the difference in the angle of displacement of the knee joint or it may be more subjectively measure by visual cues or more simply, by patient comfort.

FIG. 3 is a cross section along the line 3-3 in FIG. 2. Pad bridge arm 38 is generally rectangular shaped and sized so as to accommodate slidably adjustable pad supports 40 on the outer surface of pad bridge arm 38. Pad bridge arm 38 is secured in place by arm detents 42 in arm detent openings 41 as is shown more clearly in FIG. 2. Depending downwardly from adjustable pad supports 40, is bridge arm support tab 44 connected to pad support tabs 46 via pad pivot pin 45. Proximal compression pad 50 is generally arcuate in shape to fit more comfortably on the patient's lower thigh area above the knee. Affixed to the inner surface of proximal compression pad 50 is pad cushion 52. Pad cushion 52 may be permanently affixed or removably positioned along inner surfaces of compression pad 50 and may further provide therapeutic relief in terms of heat, cold or medication to the knee joint musculature. It will be understood that a plurality of pad cushions 52 can be employed such that force or therapeutic value can be applied on both sides of the knee joint, at the knee joint, directly above the knee joint on the inner and outer thigh area and directly below the knee joint on the inner and outer shin area. When employed in their respective compression pads 50 and 54 pad cushions 52 will also provide additional stabilization to the knee, prevent device slippage and provide an extra degree of comfort and/or medication to patient during use of the knee rehabilitation device of the present invention.

FIG. 4 is a cross-sectional view of FIG. 2 along the line 4-4. Foot support 2 for engaging the heel portion of a patient's foot is generally rectangular defined by right sidewall 4, left sidewall 6, front wall 8 all of which are attached to foot support base 10. Foot support 2 has three walls and is open on the opposite end of front wall 8 to accommodate the placement and positioning of a patient's feet of varying sizes. The lower interior surface of foot support 2 may be formed to place a patient's foot in a generally vertical or “toes-up” orientation which is optimal for use of the therapeutic device as disclosed. Optionally, interior surfaces of foot support 2, right wall 4, left wall 6 and front wall 10 may further include resilient pads or cushioning fabricated for patient comfort.

In the embodiment shown in FIG. 4, attached to left support wall 6 via handle securing pin 12 is distal arm end 20. Securing pin 12 is received by securing pin through openings in both left side wall 6 and distal arm end 20. At one side of securing pin 12 is securing pin head 16 and at the opposite end securing pin lock nut 14 which may be selectively adjustable to increase or decrease the resistance in the downward movement of arm 24 as disclosed above. In other embodiments, distal arm end 20 may be rotatably attached to either or both sides of foot support 2 and that other suitable securing means which allow rotational movement and/or which may be adjustable that are known in the art may be employed.

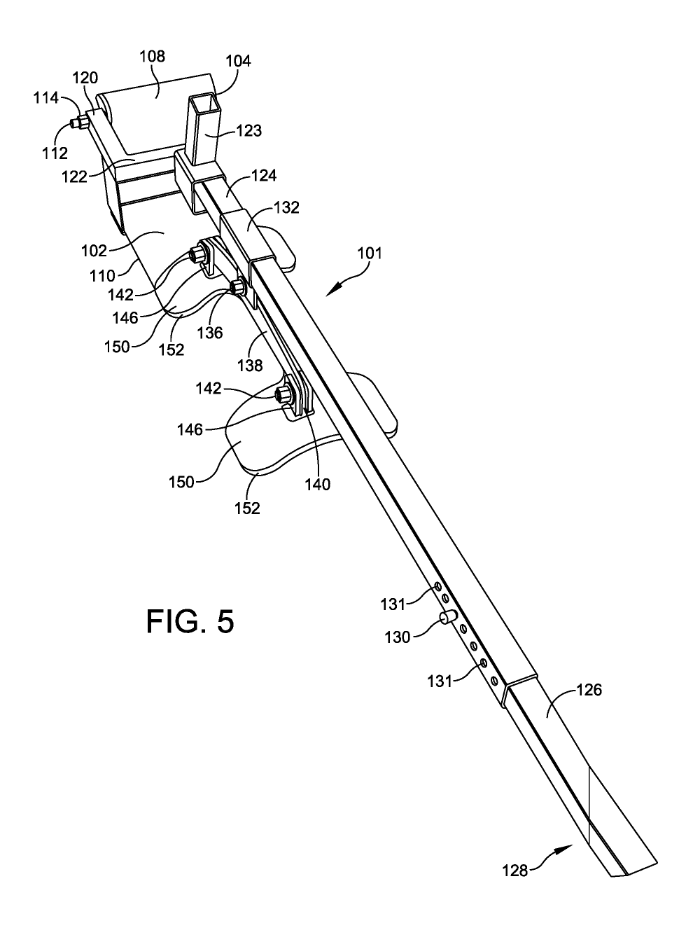

FIG. 5 is a left side perspective view of an alternate embodiment 101 of the knee rehabilitation therapy device of the present invention for facilitating the range of motion in a patient's knee. In FIG. 5 like numbers refer to like structures in the embodiments shown in FIGS. 1-4 beginning with the identification of the embodiment 101 with new or different reference numbered structures noted in the drawings. In FIG. 5, foot support 102 is generally rectangular defined by right sidewall 104, left sidewall 106, front wall 108 all of which are attached to foot support base 110. It will be appreciated that foot support 102 has three walls and is open on the opposite end of front wall 108 to accommodate the placement and positioning of a patient's foot. Foot support 102 is also open opposite the foot support base 110 and will accommodate feet of varying sizes. In certain embodiments, the lower interior surface of foot support 102 may be formed to place a patient's foot in a generally vertical or “toes-up” orientation which is optimal for use of the therapeutic device as disclosed. It will further be understood that the interior surfaces of foot support 102, right wall 104, left wall 106 and front wall 110 may further include resilient pads or cushioning fabricated for patient comfort.

In the embodiment shown in FIG. 5, rotatably attached to left support wall 106 via handle securing pin 112 is distal arm end 120. Securing pin 112 is received by securing pin through openings (not shown) in both left side wall 106 and distal arm end 120. At one side of securing pin 112 is a securing pin head (not shown) and at the opposite end securing pin lock nut 114. In the embodiment shown lock nut 114 is selectively adjustable to increase or decrease the resistance in the downward movement of arm 124. Adjustable resistance provides greater user control for applying downward pressure of the affected limb resulting in user comfort and compliance. It will be further understood that distal arm end 120 may be rotatably attached to either or both sides of foot support 102 for ease of foot insertion. Other suitable securing means which allow rotational movement and/or which may be selectively adjustable that are known in the art may be employed.

Adjacent distal arm end 120 is distal arm offset 122. Distal arm offset 122 is part of and is secured to extension tube member 124. Extension tube member 124 houses adjustable arm 126. Adjustable arm 126 is slightly smaller in generally rectangular proportion than extension tube member 124 and is slidably movable within the interior of extension tube member 124. It will be understood that adjustable arm 126 and extension tube member 124 may take other shapes and dimensions and may be rectangular or generally round and tubular. In the embodiment shown, adjustable arm 126 and extension tube member 124 are in a slidably engaged relation to one another. This allows extension tube member 124 to move proximally and distally with respect to foot support 102 to accommodate differences in patient height and patient arm reach. Optionally included are ball detents 130 which detachably secure adjustable arm 126 to extension tube member 124 via ball detent openings 131. It will be appreciated that other types of detachable connections well known within the art can be employed including but not limited to threaded thumb screws, twist lock type fittings, compression fitments, through pins and retainers as well as bead and recess type connectors for “snapping” the two segments together. It will be further appreciated that the exemplary detachably securing means can be used either alone or in combination with other detachably securing means.

Slidably positioned along extension tube member 124 are lever arm adapter 123 and bridge support member 132. In the embodiment shown, lever arm adapter 123 is configured to receive adjustable extension arm 126 which allows knee rehabilitation device 101 of the present invention to be used in a generally seated or upright position. It will be appreciated that adjustable extension arm 126 to the patient will be proximally closer when the lever arm adapter 123 is employed. While in the embodiment shown, lever arm adapter 123 is in a fixed position of between 90° to 45°, it will be further appreciated that lever arm adapter 123 can itself be adjustable for user comfort and to accommodate for differences in patient height.

Bridge support member 132 is also slidably mounted on extension tube member 124. Bridge support member 132 may also be fixedly mounted in place or it may be slidable or secured in position with set screws, pins, and or ball detents and ball detent openings (not shown).

Connected to support member 132 via compression pad pivot pin 136 is pad bridge arm 138. Compression pad pivot pin 136 allows pad bridge arm 138 to move in an up-down rocker-like fashion. Positioned at or near the proximal and distal ends of pad bridge arm 138 are adjustable pad supports 140 movably secured in place by arm detents 142 in arm detent openings (not shown). Depending downwardly from adjustable pad supports 140, bridge arm support tab 144 connected to pad support tabs 146 via pad pivot pin 145. Pad pivot pins 145 also allow proximal compression pad 150 and distal compression pad 154 to move in up-down rocker-like fashion which further facilitates adjustment and correct placement of proximal compression pad 150 and distal compression pad 154 on the lower portion of the patient's thigh and the upper portion of the patient's shin, respectively, on either side of the patient's knee to provide relatively uniform downward force when in use.

As can be seen from FIG. 5 proximal compression pad 150 is generally arcuate in shape to fit more comfortably on the patient's lower thigh area above the knee. Affixed to the inner surface of proximal compression pad 150 is pad cushion 152. Pad cushion 152 may be permanently affixed or removably positioned along inner surfaces of compression pad 150 and may further provide therapeutic relief in terms of heat or cold to the knee joint musculature. In still other embodiments pad cushion 152 can also be impregnated with transdermal medications which can provide pain relief or reduction in swelling of the affected musculature on the patient's limb. It will be understood that a plurality of pad cushions 152 can be employed such that force or therapeutic value can be applied on both sides of the knee joint, at the knee joint, directly above the knee joint on the inner and outer thigh area and directly below the knee joint on the inner and outer shin area. When employed in their respective compression pads 150 and 154 pad cushions 152 can also provide additional stabilization to the knee, prevent device slippage and provide an extra degree of comfort and/or medication to patient during use of the knee rehabilitation device of the present invention.

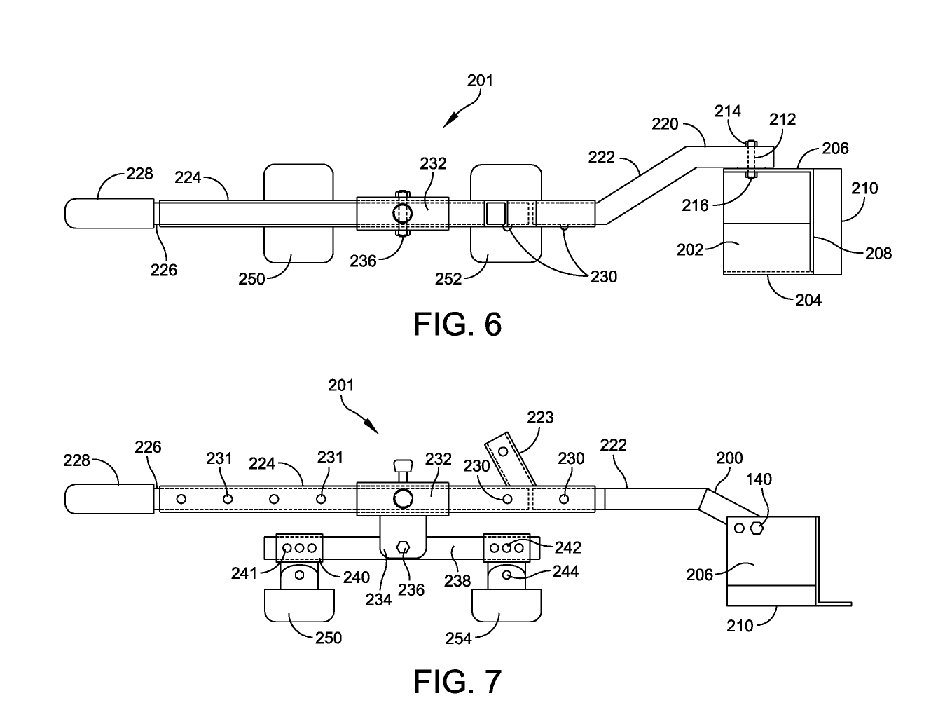

FIGS. 6 and 7 respectively show top plan and left side views of an alternate embodiment 201 of the knee rehabilitation therapy device of the present invention for facilitating the range of motion in a patient's knee. As used herein, like numbers refer to like structures in the embodiments shown in FIGS. 1-4 beginning with the identification of the embodiment 201 with new or different structures being identified below.

In FIG. 6 and FIG. 7 foot support 202 is generally rectangular defined by right sidewall 204, left sidewall 206, front wall 208 all of which are attached to foot support base 210. Foot support 202 has three walls and is open on the opposite end of front wall 208 to accommodate the placement and positioning of a patient's foot. Foot support 202 is also open opposite the foot support base 210 and will accommodate feet of varying sizes. The lower interior surface of foot support 202 is preferably formed to place a patient's foot in a generally vertical or “toes-up” orientation which is optimal for use of the therapeutic device as disclosed.

The interior surfaces of foot support 202, right wall 204, left wall 206 and front wall 210 may further include resilient pads or cushioning fabricated for patient comfort. Also housed within extension tube member 224 is adjustable arm 226 which likewise is slidably movable within extension tube member 224 and is adjustable therein and secured in place via ball detents 230 and a plurality of ball detent openings 231. The plurality of ball detent openings 231 permits the patient to selectively move adjustable arm 226 proximally or distally allowing bridge support member 232 to a placed in position by the patient which is optimal for therapy.

In the embodiment shown, slidable bridge support member 232 may be positioned and secured in place with bridge lock pin 260. In the embodiment shown, bridge lock pin 260 is preferably a spring loaded or biased pin positioned on the upper surface of bridge support member 232. Bridge support member 232 is slidably mounted on extension tube member 224 and may be temporarily adjustable and secured in position via bridge pin lock 260. The bottom portion bridge lock pin 260 mateably fits within detents or openings on the upper surface of extension tube member 224 in a manner that temporarily prevents movement of bridge support member 232 while the device is in use. Together with adjustable arm 226, bridge support member 232 also allows the device to accommodate a variety of patients of different heights and leg lengths and essentially eliminates the need for customizing the device for each patient.

Depending downwardly from bridge support member 232 is bridge arm tab 234. Connected to bridge arm tab 234 via compression pad pivot pin 236 is pad bridge arm 238. Compression pad pivot pin 236 allows pad bridge arm 238 to move in an up-down rocker-like fashion. Positioned at or near the proximal and distal ends of pad bridge arm 238 are adjustable pad supports 240 movably secured in place by arm detents 242 in arm detent openings 241. Depending downwardly from adjustable pad supports 240, bridge arm support tab 244 connected to pad support tabs 246 via pad pivot pin 245. Pad pivot pins 245 allow proximal compression pad 250 and distal compression pad 254 to move in up-down rocker-like fashion which further facilitates adjustment and correct placement of proximal compression pad 250 and distal compression pad 254 on the lower portion of the patient's thigh and the upper portion of the patient's shin, respectively, on either side of the patient's knee to provide relatively uniform therapeutic downward force when in use.

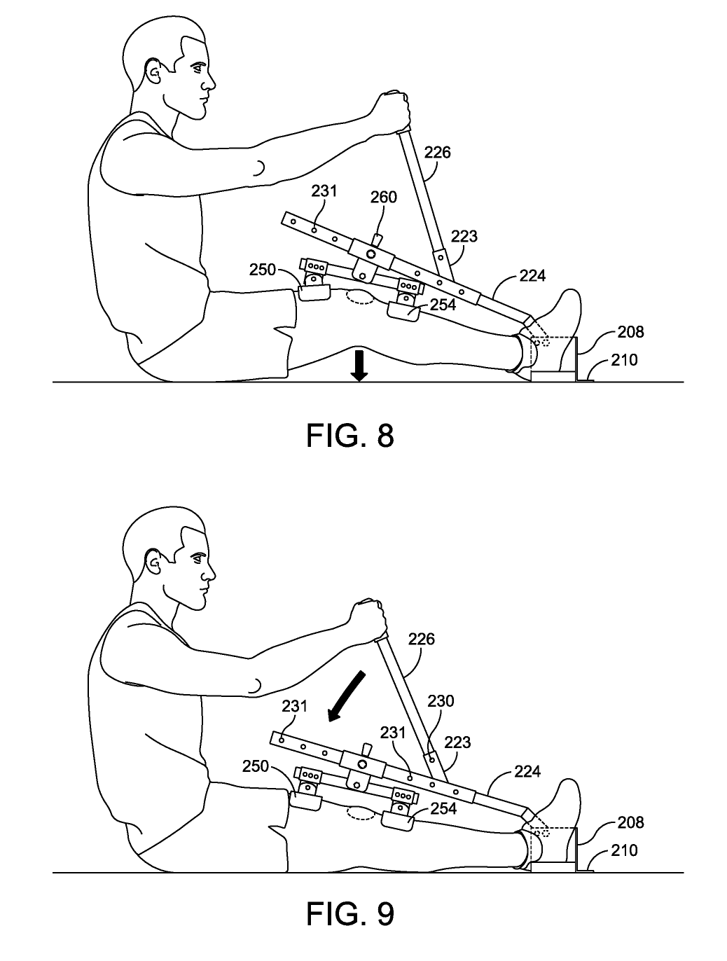

FIGS. 8-11 show an embodiment of the present invention in representative use by a patient in seated and reclined positions. For example, FIG. 8 and FIG. 9 depict the knee rehabilitation therapy device 201 of the present invention facilitating the range of motion in a patient's knee while a patient is in the seated position. In this embodiment, adjustable arm 226 is removed from within extension tube member 224 and is temporarily repositioned and secured in place within lever arm adapter 223 which receives adjustable extension arm 226. Adjustable extension arm 226 is securely held in place via ball detent 230 and at least one ball detent openings 231. Alternatively, adjustable extension arm 226 may be held in place within level arm adapter 223 by compression fitment or other temporary securing means. As shown more clearly in FIGS. 7 and 8, positioning adjustable arm 226 in this manner allows knee rehabilitation device 201 of the present invention to be used in a generally seated or upright position as adjustable extension arm 226 is proximally closer to the patient when lever arm adapter 223 is employed. Lever arm adapter 223 is shown in a fixed position of between 90° to 45°, however, it will be understood that in other embodiments lever arm adapter 223 can itself be angularly adjustable essentially from 10° to 90° for user comfort and to accommodate for differences in patient heights and arm lengths.

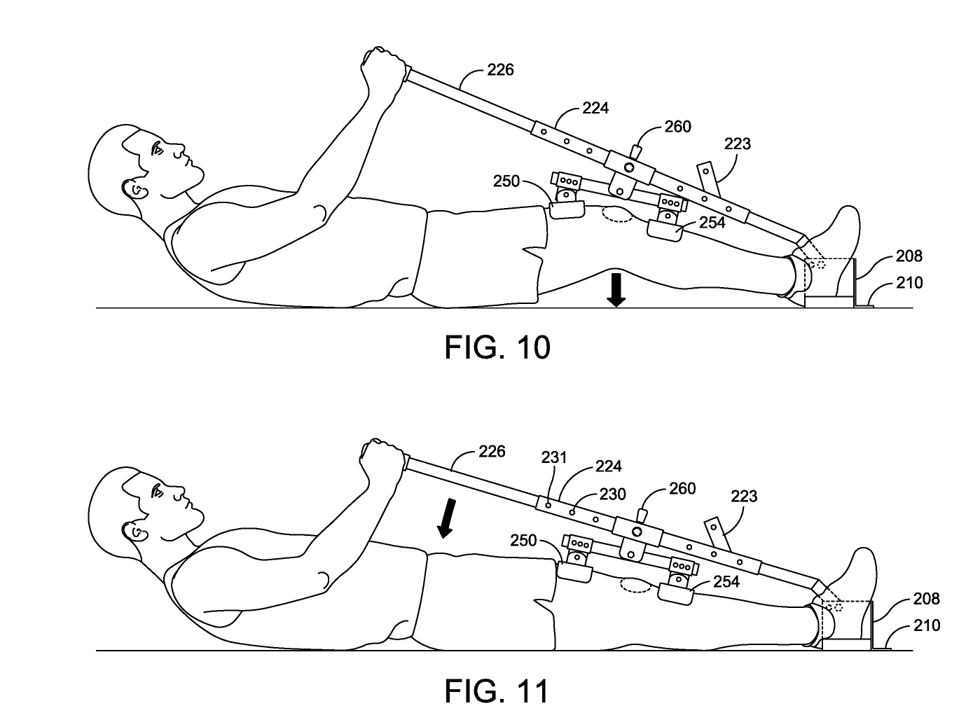

FIGS. 10 and 11, depict the knee rehabilitation therapy device 201 of the present invention facilitating the range of motion in a patient's knee while a patient is in the reclined position. In this embodiment, adjustable arm 226 is positioned within extension tube member 224 and is temporarily repositioned and secured in place via ball detents 230 and at least one ball detent opening 231. In other embodiments adjustable extension arm 226 may also be held in place within extension tube member 224 by compression fitment or any of the other temporary securing means described above. As shown more clearly in FIGS. 10 and 11, positioning adjustable arm 226 within extension tube member 224 allows knee rehabilitation device 201 of the present invention to be used not only in a generally reclined position, as shown, but when the patient is completely upright and in a standing position. It will be understood that in either a fully reclined or in a standing position, adjustable extension arm 226 can be positioned proximally closer to the patient for maximum extension of the knee joint for greater user comfort and to accommodate for differences in patient heights and arm lengths.

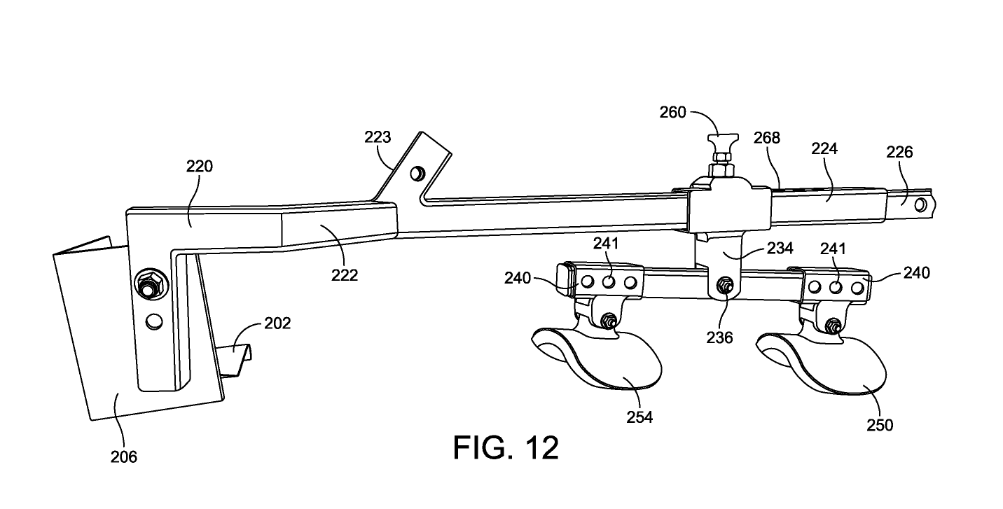

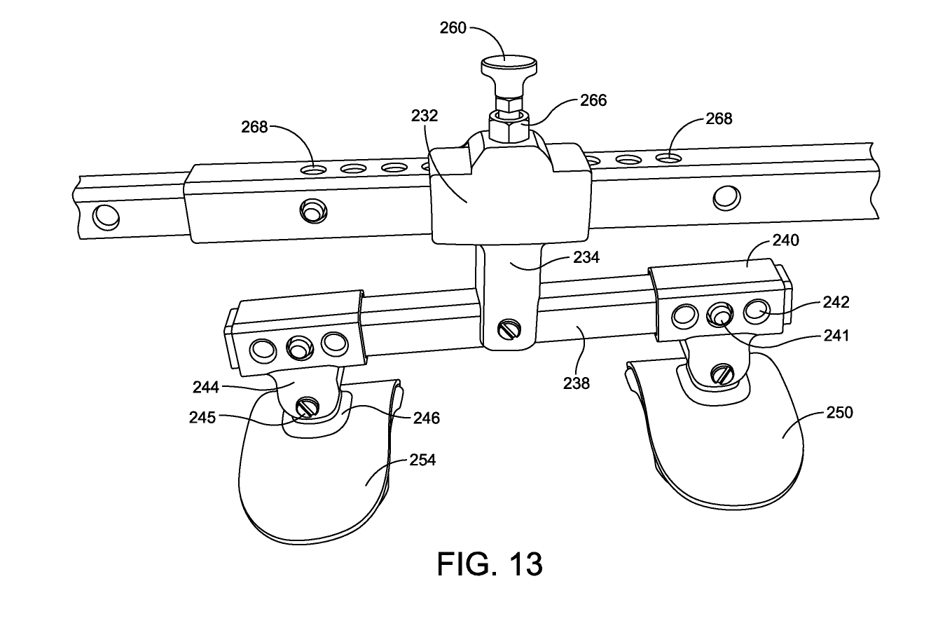

FIG. 12 and FIG. 13 are respectively, a left side view and a cut-away side view of a segment of the knee rehabilitation therapy device 201 of the present invention showing the structures and features referenced above. Adjustable bridge support member 232 is shown positioned and secured in place with bridge lock pin 260. In the embodiment shown, bridge lock pin 260 is preferably a spring loaded or spring biased pin positioned on the upper surface of bridge support member 232 secured to bridge support member 232 via lock pin support 266. Bridge lock pin 260 includes lock pin stem 262 and lock pin head 264 to facilitate gripping and releasing of bridge lock pin 260. Lock pin support 266 may further include a raised area for structural support of the bridge lock pin assembly, although it will be understood that any such raised areas are solely a matter of build preference.

As shown in FIG. 13, bridge support member 232 is slidably mounted on extension tube member 224 and that a bottom portion lock pin stem 262 will mateably fit within detents or openings 268 on the upper surface of extension tube member 224 in a manner that temporarily prevents movement of bridge support member 232 while the device is in use. Together with adjustable arm 226, adjustable bridge support member 232 also allows the device to be repositioned to accommodate a variety of patients of different heights and leg lengths and essentially eliminates the need for customizing the device for each patient.

Depending downwardly from bridge support member 232 is bridge arm tab 234. Connected to bridge arm tab 234 via compression pad pivot pin 236 is pad bridge arm 238. Compression pad pivot pin 236 allows pad bridge arm 238 to move in an up-down rocker-like fashion. Positioned at or near the proximal and distal ends of pad bridge arm 238 are adjustable pad supports 240 movably secured in place by arm ball detents 242 in arm ball detent openings 241. Depending downwardly from adjustable pad supports 240, bridge arm support tab 244 connected to pad support tabs 246 via pad pivot pin 245. Pad pivot pins 245 allow proximal compression pad 250 and distal compression pad 254 to move in up-down rocker-like fashion which further facilitates adjustment and correct placement of proximal compression pad 250 and distal compression pad 254 on the lower portion of the patient's thigh and the upper portion of the patient's shin, respectively, on either side of the patient's knee to provide relatively uniform therapeutic downward force when in use.

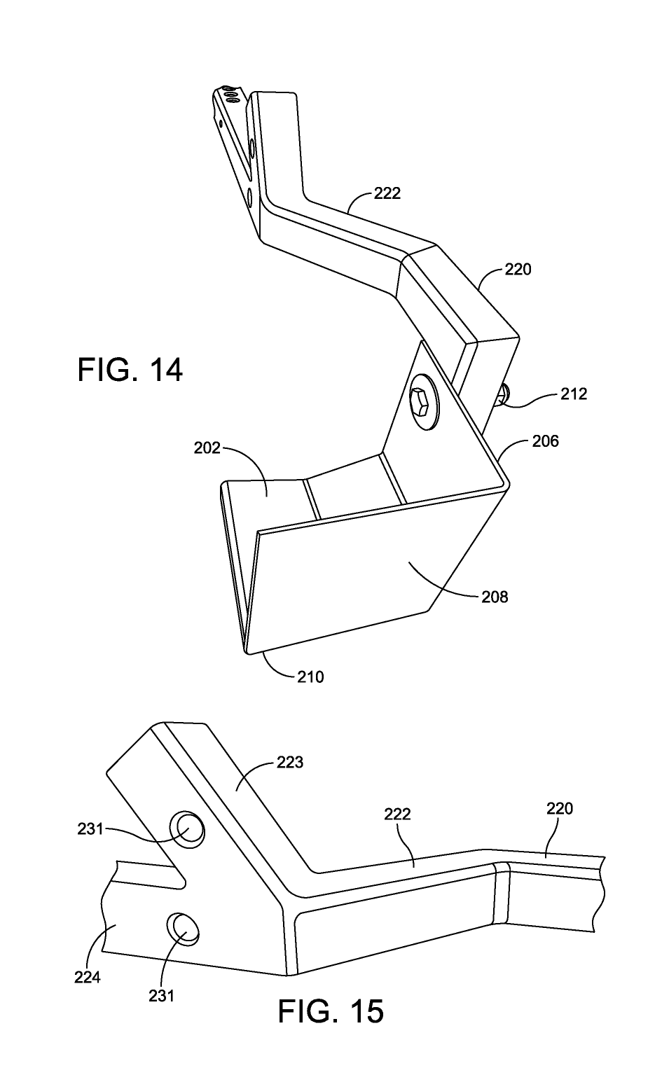

FIG. 14. is a top plan perspective view of the distal portion of the knee rehabilitation therapy device 201 of the present invention towards the proximal end. In this embodiment, foot support 202 for engaging the heel portion of a patient's foot is generally rectangular defined by left sidewall 206, front wall 208 all of which are attached to foot support base 210. Foot support 202 has at least two walls and is open on the opposite end of front wall 208 to accommodate the placement and positioning of a patient's feet of varying sizes. The lower interior surface of f

Foot support 202 may be formed to place a patient's foot in a generally vertical or “toes-up” orientation which is optimal for use of the therapeutic device as disclosed. Optionally, interior surfaces of foot support 202, may include right wall 204, in addition to left wall 206 and front wall 210 and may further include resilient pads or cushioning fabricated for patient comfort.

In the embodiment shown in FIG. 14, attached to left support wall 206 via handle securing pin 212 is distal arm end 220. Securing pin 212 is received by securing pin through openings in both left side wall 206 and distal arm end 220. At one side of securing pin 212 is securing pin head 216 and at the opposite end securing pin lock nut 224 which may be selectively adjustable to increase or decrease the resistance in the downward movement of arm 224 as disclosed above. In other embodiments, distal arm end 220 may be rotatably attached to either or both sides of foot support 202 and that other suitable securing means which allow rotational movement, and/or which may be adjustable that are known in the art may be employed.

Adjacent distal arm end 220 is distal arm offset 222. Distal arm offset 222 is part of and is secured to extension tube member 224. Extension tube member 224 houses adjustable arm 226. It will be understood that adjustable arm 226 and extension tube member 224 may take other shapes and dimensions and may be rectangular or generally round and tubular.

FIG. 15 is a partial view of a portion of the extension tube member 224 as found in FIG. 14 showing the relative position and arrangement of distal arm offset 222 and lever arm adapter 223. In the embodiment shown adjustable arm 226 is removed from extension tube member 224 and may be temporarily repositioned and secured in place within lever arm adapter 223 which is adapted to receive adjustable extension arm 226. It will be appreciated that adjustable extension arm 226 (not shown) may be securely held in place via ball detent 230 (not shown) positioned on adjustable extension arm 226 and at least one ball detent openings 231. Alternatively, the adjustable extension arm may be held in place within level arm adapter 223 by compression fitment or other temporary securing means.

In the embodiments shown in FIGS. 1-15, it will be understood that additional features such as monitors and apparatus to measure and record various therapeutic milestones and indicators associated with the use of the present invention including, for example, the duration of a given rehabilitation regimen, the history of the relative range of motion over a given time frame, the pressure required to achieve a particular improvement in the range of motion, tactile, visual and audible feedback may be incorporated and are considered within the scope of the drawings and claims.

While the embodiment shown and described above and in the drawings is directed principally to the rehabilitation of the knee joint, it will also be appreciated that the present invention can be readily adapted with minor, if any modifications, except perhaps size and location of the compression pads, for use on other human limb joints to increase flexion and range of motion. These joints would include but would not be limited to portions of the spine, the shoulder, elbow, wrist, hand and finger joints as well as the foot/ankle complex. In certain of these embodiments, it may be desirable to have a patient assistant to operate the lever arm to provide downward pressure to the affected limb joint and to impart a rotation movement to a lower portion of the affected patient limb onto which therapeutic action is desired.

From the foregoing detailed description and examples, it will be evident that these and modifications and variations can be made in the apparatus of the invention without departing from the spirit or scope of the invention. Therefore, it is intended that all modifications and verifications not departing from the spirit of the invention come within the scope of the claims and their equivalents.

What I claim is:

1. A rehabilitation device for facilitating an increase in the range of motion in a patient knee, comprising:
a foot support member;
an extension arm member having distal and proximal ends, said extension arm member rotatably coupled at the distal end to said foot support member and an adjustable handle grip member at the proximal end;
an adjustable bridge support member disposed on said extension arm member between said distal and proximal ends, said bridge support member comprising at least one compression pad for providing downward pressure to a portion of the patient knee joint, said at least one compression pad pivotally connected to said bridge support member;
wherein when the rehabilitation device is operably disposed with respect to a knee joint of the patient and further wherein the patient leg is supported on a general flat surface, the handle grip member is operatively engaged to a downward pressure and impart a rotation to a lower leg of the patient thereby facilitating increase in the range of motion.

2. The rehabilitation device of claim 1 further comprising a distal arm offset detachably secured to said extension arm member.

3. The rehabilitation device of claim 1 further comprising a plurality of cushion pads and a plurality of compression pads.

4. The rehabilitation device of claim 1 wherein said adjustable handle grip member is detachably secured to said extension arm member.

5. The rehabilitation device of claim 4 wherein said adjustable handle grip member is detachably secured by connections selected from the group consisting of balls and detents, threaded thumb screws, twist lock fittings, compression fitments, through-pins and retainers and bead and recess type connectors.

6. The rehabilitation device of claim 3 wherein the at least one compression pad further comprises pad cushions.

7. The rehabilitation device of claim 6 wherein the pad cushions further comprise means for providing therapeutic relief to the affected knee joint area.

8. The rehabilitation device of claim 7 wherein the therapeutic relief means are selected from the group consisting of heat pads, cold pads, medication impregnated pads and combinations thereof.

9. The rehabilitation device of claim 3 wherein each of the plurality of compression pads further comprises at least one pad cushion.

10. The rehabilitation device of claim 9 wherein the pad cushions further comprise means for providing therapeutic relief to the affected knee joint area.

11. The rehabilitation device of claim 10 wherein the therapeutic relief means are selected from the group consisting of heat pads, cold pads and medication impregnated pads.

12. A rehabilitation device, for facilitating an increase in the range of motion in a patient knee comprising:
a foot support;
a handle having a distal end and a proximal end, said distal end rotatably coupled to said foot support;
a bridge support member disposed on said extension arm member between said distal and proximal ends, said bridge support member comprising a pair of compression pad members for providing downward pressure to a portion of the patient knee joint, said compression pad members pivotally connected to said bridge support member;
a locking mechanism operable to releasably lock the handle at a plurality of different angular positions relative to the foot support;
recorder for measuring and recording a first range of motion and a second range of motion; wherein when the compression pad members are operably disposed with respect to a knee joint of the patient and further wherein the handle grip member is operatively engaged to a downward pressure and impart a rotation to a lower leg of the patient, the increase in the range of motion from a first range of motion to a second range of motion can be recorded.

13. The rehabilitation device of claim 12 further comprising a monitor function to measure and record therapeutic regimen selected from the group consisting of time, rotation R-max, range of motion and downward pressure.

14. The rehabilitation device of claim 13 further comprising tactile, visual and audible feedback means.

15. A limb straightening device for facilitating an increase in the range of motion in a patient limb joint, comprising:
a limb joint support member;
an extension arm member having distal and proximal ends, said extension arm member rotatably coupled at the distal end to said limb joint support member and an adjustable handle grip member at the proximal end;
an adjustable bridge support member disposed on said extension arm member between said distal and proximal ends, said bridge support member comprising at least one compression pad for providing downward pressure to a portion of the patient limb joint, said at least one compression pad pivotally connected to said bridge support member;
wherein when the straightening device is operably disposed with respect to a limb joint of the patient and further wherein the patient limb is supported on a general flat surface, the handle grip member is operatively engaged to a downward pressure and impart a rotation to a lower portion of the patient limb joint thereby facilitating increase in the range of motion.

16. The limb straightening device of claim 15 wherein the at least one compression pad further comprises a pad cushion containing means for providing therapeutic relief to the affected limb joint area.

17. The rehabilitation device of claim 15 further comprising a plurality of compression pads.

18. The limb straightening device of claim 16 wherein the therapeutic relief means are selected from the group consisting of heat pads, cold pads and medication impregnated pads.

19. The limb straightening device of claim 17 wherein the plurality of compression pad comprises pad cushions and further comprise means for providing therapeutic relief to the affected limb joint area.

20. The limb straightening device of claim 19 wherein the therapeutic relief means are selected from the group consisting of heat pads, cold pads, medication impregnated pads and combinations thereof.
